(19) United States
(12) Patent Application Publication
(10) Pub. No.: US 2016/0342713 A1
(43) Pub. Date: Nov. 24, 2016

(54) PROVIDING DESIGN DNA OF A NON-BIOLOGICAL PRODUCT

(71) Applicant: Autodesk, Inc., San Rafael, CA (US)

(72) Inventors: Mary Hope McQuiston, Larkspur, CA (US); James Sherwood Page, Berkeley, CA (US); Anthony Christopher Kipkirui Yegon Ruto, Basingstoke (GB); Gordon Kurtenbach, Toronto (CA); Hans Kellner, Oakland, CA (US)

(21) Appl. No.: 14/719,264

(22) Filed: May 21, 2015

(51) Int. Cl. G06F 17/50

(52) U.S. Cl. CPC G06F 17/50; G06F 17/5095

(57) ABSTRACT

Methods, systems, and apparatus, including computer programs encoded on computer storage media, for providing design DNA for a non-biological product. One of the methods includes, identifying an instantiation of a product, the product being non-biologic and being a manufactured item; determining design parameters to be associated with the instantiation of the product. The determining includes: evaluating the instantiation of the product, determining a design intent including an intended use or life of the instantiation of the product, and determining design parameters that were used in developing a design associated with the instantiation of the product. The method further includes, storing the determined design parameters inseparably with the instantiation of the product; and after the instantiation of the product is deployed, retrieving, from the instantiation of the product, the stored determined design parameters; and using the retrieved determined design parameters to evaluate the instantiation of the product.

### TECHNICAL FIELD

This specification relates to providing design DNA of a non-biological product.

### BACKGROUND

A manufactured item's original design data may be important for reproducing or modifying the design of the item. Thus, providing readily available access to these design data can be important, especially after a manufactured item has long left the design stage.

### SUMMARY

In general, this specification describes technologies for providing product design DNA of a non-biological product, e.g., a car engine or a gear box, so that the product design DNA, e.g., design parameters originally used in manufacturing the product, can be readily identified to facilitate future reproduction of or modification to the product.

In general, one innovative aspect of the subject matter described in this specification can be embodied in methods that include the actions of identifying an instantiation of a product, the product being non-biologic and being a manufactured item; determining design parameters to be associated with the instantiation of the product. The determining includes: evaluating the instantiation of the product, determining a design intent including an intended use or life of the instantiation of the product, and determining design parameters that were used in developing a design associated with the instantiation of the product. The method further includes, storing the determined design parameters inseparably with the instantiation of the product; and after the instantiation of the product is deployed, retrieving, from the instantiation of the product, the stored determined design parameters; and using the retrieved determined design parameters to evaluate the instantiation of the product.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. Efforts for identifying a product's original design after the product has long left factory or by a party not in possession of the original design can be reduced: design parameters can be stored physically or electronically within the product and can thus be readily located and retrieved when needed. Overhead and dependencies arising from memorizing these design parameters separately from the product, e.g., in an external online database, can also be reduced: all future references to the original design parameters can be satisfied by reading necessary data stored with the product itself. The design parameters of a product stays, e.g., are stored inseparably, with the product. Therefore, as long as a user has access to the product, the user can access the design parameters of the product.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example system for providing design DNA of a non-biological product.

FIG. 2 is a flow diagram illustrating an example process for providing design DNA of a non-biological product.

FIG. 3 is a block diagram illustrating an example system for identifying design DNA of and storing the collected design DNA on a non-biological product.

FIG. 4 is a block diagram illustrating an example system for retrieving design DNA from a non-biological product after the non-biological product is deployed.

Like reference numbers and designations in the various drawings indicate like elements.

### DETAILED DESCRIPTION

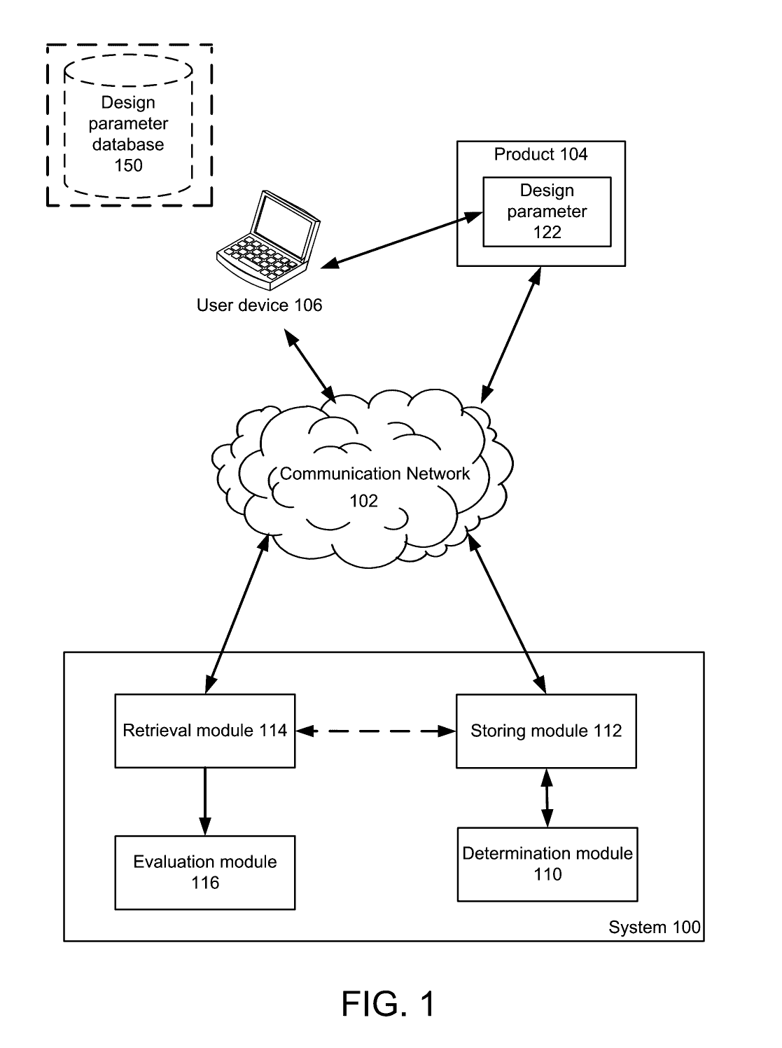

FIG. 1 is a block diagram illustrating an example system 100 for providing design DNA of a non-biological product.

The system 100 includes a determination module 110, a storing module 112, a retrieval module 114, and an evaluation module 116. The system 100 determines one or more design parameters of a manufactured item, e.g., a car engine or a gear box, and stores these design parameters inseparably with the manufactured item.

After a manufacture item is deployed, e.g., put to use in a production environment, the system 100 can retrieve, from the item, one or more of these design parameters in order to evaluate, reproduce, or replicate the item.

For example, as indicated by the dotted line surrounding the design parameter database 150 in FIG. 1, when references to design parameters stored externally are impossible, infeasible, unavailable, or otherwise undesirable, e.g., the design parameter database 150 is permanently or temporarily disabled, taken offline, or requires a subscription fee, the design parameters stored in the product 104 can be retrieved.

The determination module 110 can determine design parameters of a manufactured item. The determination module 110 may evaluate the manufactured item to determine or estimate one or more original dimensional measurements, e.g., height, width, or length, or design intent of the manufactured item. A design intent may include intended fields of use, directions or instructions for carrying out an intended use, and intended life spans of a manufactured item under different operating circumstance.

Evaluating a manufactured item may involve, but does not require, a physical copy of the item, for example, when optically scanning the contour or structure of a gear to determine the 3D measurements of the gear. Evaluating a manufactured item may involve reading design data from a design blueprint of the item, for example, when reading 3D measurement of a gear from a computer added design (CAD) system or a 3D printing system.

The storing module 112 can store one or more design parameters determined by the determination module 110 inseparably with the manufactured item. For example, the storing module 112 may store design parameters that are necessary for reproducing a stainless steel car transmission box in a RFID chip and physically attach the RFID chip to the transmission box and coat the RFID chip with high-heat resistant materials, such that 5 years after the transmission box is placed in service, the design parameters stored in the RFID chip can still be retrieved, e.g., electronically read, in order to reproduce a transmission box with identical or similar designs.

The retrieval module 114 can retrieve design parameters stored inseparably with a manufactured item, e.g., wirelessly or through a wired connection. The retrieval module 114 can be a data reader that has been configured to read design data from a manufactured item. For example, when reading design data of a vehicle, which has been stored in the vehicle's microprocessor system, the retrieval module 114 can be a car diagnostic tool that reads data from the vehicle's microprocessor system. For example, the retrieval module 114 can also be a RFID reader, which can retrieve 3D measurements of a transmission box stored in a RFID chip.

The evaluation module 116 can evaluate the performance of a manufactured item, e.g., in accordance with current conditions of the item and the original design parameters of the item. For example, the evaluation module 116 can generate graphic charts comparing a car transmission box's expected life span, as specified in the original design parameters, and its actual life span. Based on these evaluations, a manufactured item's design can be replicated to provide similar future performance or modified to improve future performance.

The communication network 104 interconnects a product 104 and a user device 106 with each other and with the system 100. The communication network 104 may include the Internet, one or more local area networks (LANs), one or more wide area networks (WANs), other types of networks, or a combination of such networks.

The user device 104 can read design parameter stored on the product 104 and selectively provide one or more design parameters to the system 100. The user device 104 can also provide, to a user, a presentation of design parameters retrieved by the retrieval module 114 and evaluation or comparison results generated by the evaluation module 116. In some implementations, the user device 104 achieves these functions by using a CAD system.

The design parameters database 150, which is also referred to in this specification as the external source of the design parameters 122, may also store a copy of the design parameter 122. As indicated by the surrounding dotted lines, however, the design parameters database 150 may be unavailable or undesirable for accessing the copy of the design parameter 122 stored thereon. For example, the design parameters database 150 may be taken offline or require an access fee, or the design parameters database 150 cannot be relied on for lack of data integrity.

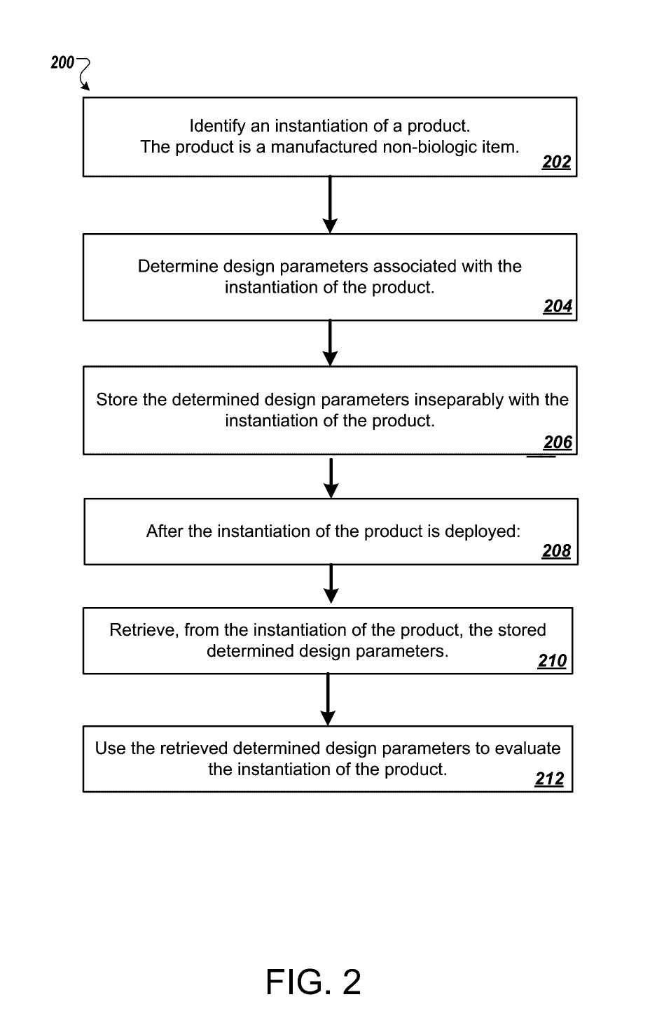

FIG. 2 is a flow diagram illustrating an example process 200 for providing design DNA of a non-biological product. For convenience, the process 200 will be described as being performed by a system of one or more computers, located in one or more locations, and programmed appropriately in accordance with this specification. For example, the system 100 of FIG. 1, appropriately programmed, can perform the process 200.

The process 200 begins with identifying an instantiation of a product that is a manufactured non-biologic item (202), e.g., a car engine, a gear, an airplane, a nut-and-bolt pair, a mobile phone, a desk lamp, a night stand, an office chair, or a pair of shoes. The product is non-biological means that the product is not exclusively consisted of living organisms, such as a plant, a fruit, or an animal.

When a product has more than one configuration, e.g., having various different sizes, shapes, or made-of materials, each configuration is referred to in this specification as one instantiation of the product.

For example, when a baking dish can be manufactured in 3 different shapes, e.g., square, rectangle, or round, each shape version of the baking dish is one instantiation of the baking dish. For another example, when a gear can be manufactured in 3 different sizes, e.g., a small size, a medium size, and a large size, each size version of the gear is one instantiation of the gear. For a third example, when a cooking pan can be manufactured in 3 different materials, e.g., metal, stainless steel, and cast iron, each material version of the cooking pan is one instantiation of the cooking pan.

Once an instantiation of a product is identified, design parameters associated with the instantiation of the product are determined (204).

Determining the design parameters associated with the instantiation of the product includes: evaluating the instantiation of the product; determining a design intent including an intended use or life of the instantiation of the product; and determining the design parameters that were used in developing a design associated with the instantiation of the product.

In some implementations, design parameters of a product are determined before the product is manufactured. For example, design parameters of a product can be determined from a CAD software application used to design the product. For example, the 3D measurements of a gear may be determined by analyzing design data generated by the CAD application, using which the gear is designed. For another example, a gear may be photographed and its image optically analyzed to determine

In other implementations, design parameters are determined after a product is manufactured or even after the product has been deployed for service. For example, a vintage vehicle and its sub-components, e.g., the engine, the transmission box, and the frame, may be photographed and their images analyzed, e.g., using object, color, and boundary recognition as well as other image processing techniques, to determine design parameters of the vehicle and the sub-components.

The determined design parameters are stored inseparably with the instantiation of the product (206). Note that the design parameters themselves—rather than references to the design parameters, e.g., URLs, database locations, design document index numbers, or other references for locating these design parameters from an external source—are stored inseparably with the instantiation of the product.

This technique is advantageous, because, for the purpose of future data retrieval, storing references to data stored or located externally can be less reliable and thus less desirable than storing the data itself. Because data that are stored externally can become unexpectedly unavailable. For example, design parameters of a product stored on a manufacturer's website may become unavailable when the manufacturer goes out of business or discontinues the product. In contrast, storing design parameters on the product itself, especially when inseparably from the product, can reduce or avoid at least the above-described difficulties arising from storing only references to the design parameters.

In some implementations, the determined design parameters are stored in a storage unit that is physically attached to the instantiation of the product. In this specification, two entities, e.g., parts or components, are inseparable from each other if they are attached to each other electronically, physically, mechanically, or magnetically, and would not separate from each other absent a predefined amount of external force. For example, 3D measurements and manufacturing instructions of a gear box can be stored in an RFID chip that is welded to or embedded in the gear box; the RFID chip could not be separated from the gear box unless forces are used to unweld or dislodge the RFID chip from the gear box.

In some implementations, design parameters are stored in a persistent memory storage unit that is physically attached to an instantiation of the product. For example, original design intents and design assumptions of a mobile phone may be stored in a read-only persistent data storage that is part of the mobile phone, e.g., a RFID chip inside the phone or a portion of the phone's persistent memory. In some implementations, design parameters are stored in a UHF tag, which can have a bigger storage capacity than a RFID chip.

To understand the original design intents and assumptions to evaluate or improve the performance of the mobile phone, a user can access the design parameters stored on the read-only persistent data storage, e.g., using a RFID reader. These techniques are particularly advantageous, when the original design stage of the mobile phone has concluded for a predefined time period: external source may have become unavailable and human memory may become unreliable.

For another example, 3D measurements, e.g., 2″ (length)*3.4″ (width)*4″ (height), of a gear box are stored on a metal barcode embedded into the gear box, such that a barcode reader can read the barcode to determine the 3D measurements of the gear box at a later time. Note that in this example, the barcode itself includes the 3D measurements and thus no references to external sources are needed. For example, the barcode reader does not need to be connected to an online barcode database in order to determine the 3D measurements of the gear box from the barcode; accessing the barcode alone would suffice to determine the 3D measurements of the gear box.

In some implementations, the machine detectable format in which design parameters are stored is not readily humanly understandable. This is advantageous, as it allows the design parameters of a product to be encrypted and accessible only by certain means, e.g., through an authorized decryption device. These technique can be used to protect design parameters that may be considered commercially valuable when kept secretive, at least at the time the design parameters are stored inseparably with the product.

In some implementations, design parameters are stored in a humanly detectable format, e.g., to further reduce user efforts for access the design parameters. For example, 3D measurements, e.g., 2″ (length)*3.4″ (width)*4″ (height), of a gear box may be engraved in a natural language format on the bottom surface the gear box, such that a user can read the engravings to determine the 3D measurements at a later time. For another example, a composition of different materials used in an alloy nut-and-bolt pair may be written in braille characters on the top surface of the nut, such that a user can determine the composition by “reading,” e.g., touching, the braille characters.

When design parameters are stored inseparably with an instantiation of a product, the instantiation of the product is deployed. Deploying a product may include testing the product in a production or testing environment over a predefined time period, or putting the product to use in an intended or unintended field. For example, deploying a gear box may include continuously operating a vehicle on which the gear box is installed for 100,000 miles or 5 years, in order to exam the gear box's performance in a heat intensive environment. For example, deploying a car engine may include installing the car engine into a passenger car and running the passenger car's engine until the first failure occurs.

The instantiation of the product are evaluated (212), after it has been deployed for a predefined time period. To this end, design parameters stored inseparably with and descriptive of the instantiation of the product need to be retrieved (210).

In some implementations, evaluating the instantiation of the product may include using the retrieved design parameters to replicate or reproduce a copy of the instantiation of the product or a different instantiation of the product. For example, composition of materials used in an alloy gear can be retrieved to reproduce gears with the identical composition. For example, composition of materials used in an alloy gear can be retrieved to evaluate the performance of each material under a particular working environment, e.g., a year-round freezing temperature, so that a different composition having a more low-temperature tolerant or resistant characteristic can be used to manufacture the gear.

In some implementations, the product is an assembly of multiple sub-assemblies, e.g., sub-components or parts. For example, a gear box may include multiple gears connected by multiple axles. In these implementations, evaluating the instantiation of the product includes determining sub-assemblies and parts associated with the assembly and determining instructions for manufacturing or assembling the assembly using the sub-assemblies and parts. For example, the design parameters may describe different ways and sequences for connecting gears and axles that are part of a gear box or include instructions for assembling the gears and the axles into the gear box or properly disassembling the gear box into individual gears and axles.

In some implementations, the design parameters include information that is material, e.g., essential or necessary, for manufacturing or 3D printing the instantiation of the product. For example, design parameters of a gear box may describe the composition of materials of which each gear and axle in the gear box is made or computer graphics and geometry data for enabling 3D printing of the gear box by different 3D printing systems.

In some implementations, determining the design parameters includes determining the design parameters pre-manufacturing, e.g., at the design stage. For example, the CAD software applications used to design a product, the geometry of the design, the loading (e.g., defined as boundary conditions in the software), the simulation of the design under load (e.g., identifying critical stress, displacement, and other information relating to use), location and installation information (when the product is part of an assembly), and other relevant identification formation (e.g. serial number) can be captured and saved to a digital file. The digital file can be stored in a remote server that links the file to the serial number and the serial number stored on an RFID chip or barcode that is embedded in the manufactured part. Alternatively, the digital file could be compressed and encoded into physical media (e.g., USB, SD, miniSD etc.) that is embedded safely in a manufactured product.

In some implementations, determining the design parameters includes determining not only input parameters for the design of an instantiation of a product, but also algorithms employed on the input parameters. For example, design parameters of a gear box may include original dimensions of the gear box, as well as the mathematical algorithms used to determine these dimensions based on spatial relationships between the sub-components within the gear box. For example, the design parameters of a gear box can include not only the sizes of individual gears, but also how these sizes are chosen or determined, in view of the size of the gear box and the sizes of the connecting axles.

In some implementations, determining the design parameters includes determining one or more characteristics of the instantiation of the product that are unique or included in the instantiation and different from other instantiations of the product. For example, design parameters of an instantiation of a product may include distinguishing factor that make the instant instantiation different from other instantiations of the same product. For example, the design parameters of an alloy gear box may describe how the alloy differs from alloys used in other similar gear boxes, e.g., in term of material composition, and reasons for using a particular composition.

In some implementations, when a product includes multiple sub-components, design parameters of an instantiation of a product are stored on a selected sub-component. For example, 3D printing parameters of a cell phone may be stored in the persistent memory of the cell phone. For example, assembling instructions a gear box may be engraved on the bottom surface of the cover of the gear box. These techniques are advantageous, because when design parameters are stored on a part of a product, it is more likely that the design parameters are inseparable from the product, which in turn reduces user efforts required for referencing these design parameters in the future.

In some implementations, design parameters specify performance expectation of a product, e.g., how long a gear box is expect to be continuously in a working condition under normal operating circumstances. And design parameters retrieved from different instantiations of a product can be analyzed to compare the performances of these different instantiations. For example, performance expectations can be understood from design parameters of a stainless steel gear and a cast iron gear, and the performances of the stainless steel gear and the cast iron gear can be then compared in order to evaluate whether a specific instantiation offers a superior performance and based on these comparisons and evaluations, further improvement to the product can be made.

In some implementations, design parameters of an instantiation of a product also identify a design intent or goal of the instantiation of the product. For example, design parameters of a stainless steel gear may specify the intended fields or conditions of use for the gear, e.g., the gear is intended as a light duty backup gear rather than the primary gear in a set of torque-producing gears and should not need replacement until after 5 years of service. Performance of a product during a particular time period can be compared with the intended goal of the product to evaluate the product's performance.

In some implementations, design parameters of an instantiation of a product also identify an expected performance of the instantiation of the product. For example, design parameters of an aerospace bracket may specify the maximum amount of force or stress tolerable by the bracket, e.g., as estimated by manufacturing or design engineers. When installing the bracket to other components, users, e.g., engineers, can take into account the force tolerance and, for example, limit the use of the bracket to appropriate installations i.e. where expected load or force will not lead to stresses or displacements that lie outside the force tolerance in order to prevent failure.

In some implementations, expected performance of an instantiation of a product is determined post-manufacturing. For example, after an aerospace bracket is manufactured, the bracket is tested to determine a maximum amount of force or stress tolerable by the bracket. The maximum amount of force or stress can be included as part of the design parameters. In other words, an entity other than the original manufacture of an instantiation of a product can modify, e.g., add, remove, or edit, design parameters of the instantiation post-manufacturing. This is advantageous, as some data, e.g., test data, are not available before a product has been manufactured, and these techniques allow users to modify a product's DNA post-manufacturing.

In some implementations, design parameters of an instantiation of a product also includes design history. The design history includes references to related products, e.g., previous version of the same instantiation, or a parent product from which the instantiation inherits characteristics. A reference to a parent product may be a unique ID. All information necessary for reproducing of the product are maintained with the object, as opposed to the only information unique to its derivation. For example, if product B derives from product A and differs from product A in one aspect, then, in some implementation, the design parameters of the product B would include not only that difference, but also the rest of the design parameters of the product A. These techniques are advantageous, because they enable the reproduction of the product B based, e.g., solely, on design parameters stored with the product B—without requiring design parameters of the product A, which might not be available without having an instantiation of the product A.

In some implementations, the techniques described in this specification are performed by the original manufacturer of a manufactured item. In other words, the manufacturer can determine the design parameters of a product and store the design parameters with the product, e.g., before deploying the product, for the convenience of product users.

In some implementations, the techniques described in this specification are performed by an entity other than the original manufacturer of a manufactured item. For example, a company that services a product can determine the design parameters of the product and store the design parameters with the product, e.g., after the product is deployed and put in service, for the convenience of future service by the same or different companies or for the convenience of product users.

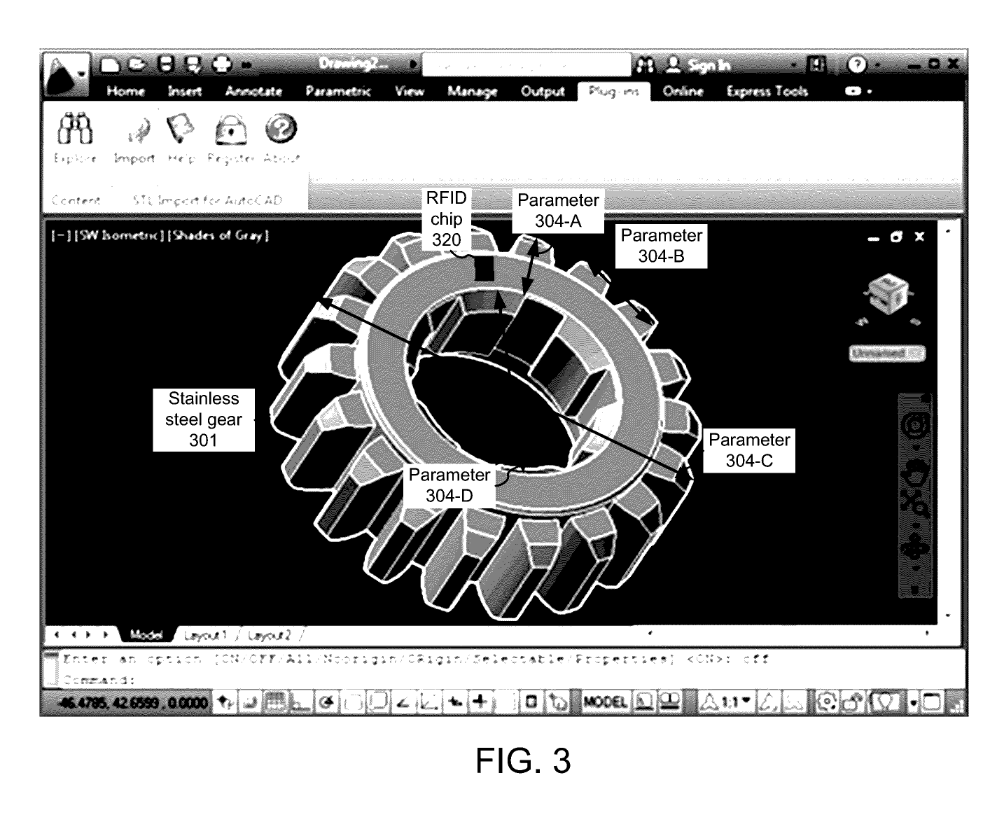

FIG. 3 is a block diagram illustrating an example system for identifying design DNA of and storing the collected design DNA on a non-biological product.

The system 300 includes one or more computers located in one or more locations and is programmed appropriately in accordance with this specification. For example, the system 100 of FIG. 1, appropriately programmed, can perform the functions of the system 300.

The system identifies one or more design parameters of a stainless steel gear 301 from a design document of the gear.

The system can selectively determine one or more design parameters of the gear accordingly to the design document, e.g., by reading data from the design blueprint shown in the document.

The system could, but does not need to, collect all design parameters related to the gear. In some implementations, only design parameters that are material to reproduce an identical copy of the gear are collected. In some implementations, only design parameters that are material to evaluate the original design intent of the gear are collected. In some implementations, only design parameters that are not readily measurable, e.g., either by a human or by a machine, are collected, e.g., intended fields of use or expected life spans of the gear under different operating environments. These techniques ensure that necessary data are collected without causing undue data storage burden.

As shown in FIG. 3, design parameters 304-A, 304-B, 304-C, and 304-D are collected from the design document of the gear 301. The design parameter 304-A represents the width between a gear tooth and the inner surface of the gear; the design parameter 304-B represents the width between two neighbor gear teeth; the design parameter 304-C represents the outer diameter of the gear; and the design parameter 304-D represents the inner diameter of the gear.

The system stores the design parameters 304-A, 304-B, 304-C, and 304-D on an RFID chip 320. In some implementations, the RFID chip 320 is read-only to prevent modifications, inadvertent or intentional, to the data stored thereon. In some implementations, the RFID chip 320 is coated with materials that would protect the RFID chip and the data stored thereon from adversities that may occur during the gear's course of operation and interfere with future data retrieval, e.g., high/low temperatures, humidity, or physical forces. In some implementations, the size of the RFID chip 320 is selected to avoid interference with the normal operation of the gear.

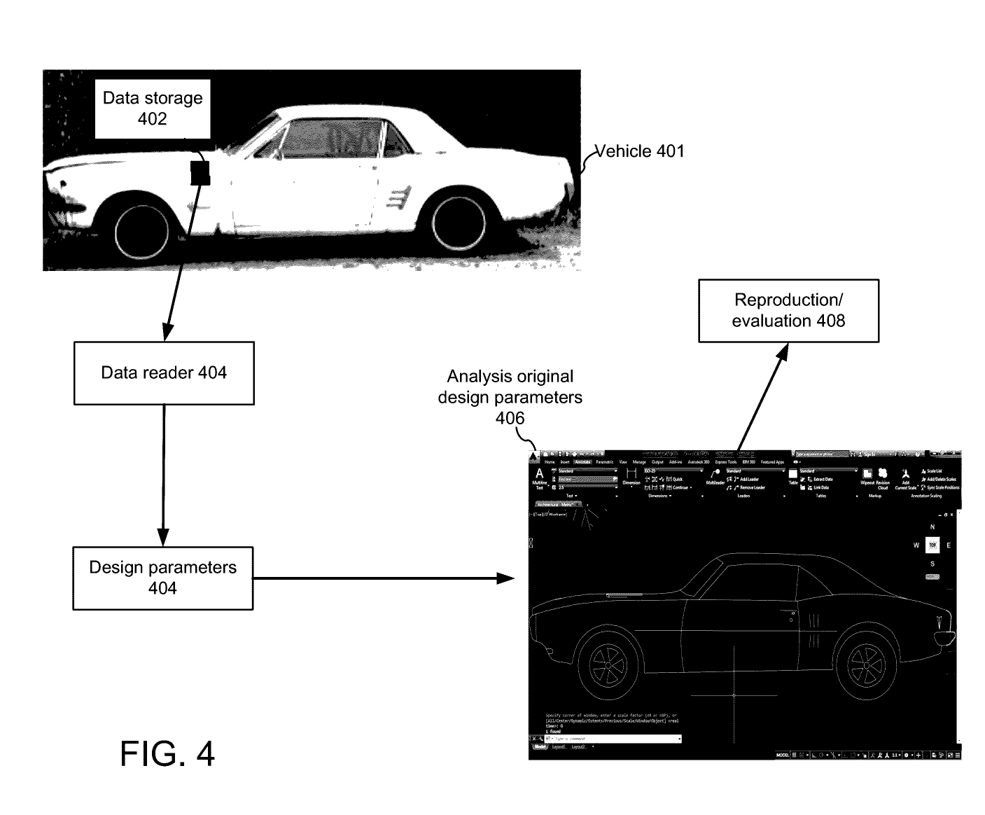

FIG. 4 is a block diagram illustrating an example system 400 for retrieving design DNA from a non-biological product after the non-biological product is deployed.

The system 400 includes one or more computers located in one or more locations and is programmed appropriately in accordance with this specification. For example, the system 100 of FIG. 1, appropriately programmed, can perform the functions of the system 400.

The system 400 may include a data reader, e.g., in ways of a software program, a hardware component, or a combination of both.

The data storage 402 contains original design parameters of the vehicle 401. In some implementations, the data storage 402 can communicate with the data read to allow the data read to pin out the location of the data storage 402 with the vehicle 401. For example, the data storage 402 may be a RFID component that emits RF signals, which allow the data reader 404 to locate the RFID component within the vehicle 401, e.g., to determine whether the data storage 402 is inside a GPS device installed on the vehicle or attached to an engine control microprocessor installed on the vehicle.

Once locating the data storage 402, the data reader 404 retrieves, e.g., wirelessly or through a wired connected, one or more of the original design parameters from the data storage 402.

In some implementations, the original design parameters are selectively retrieved in accordance with a goal, which a user can specify on the data reader 404. For example, if a user would like to review design parameters relating to reproducing the visual appearance the vehicle 401, design parameters relating to the look and feel of the vehicle 401 are retrieved, and design parameters relating to engine performance need not be retrieved.

In some implementations, the retrieved design parameters 404 are analyzed using a CAD system, which may be part of the system 400. A design blueprint may be reconstructed based on the retrieved design parameters 404 and provided for user analysis. An original design intent may be identified based on the retrieved design parameters 404. And instructions for assembling or dis-assembling components of the vehicle 401 may also be identified based on the retrieved design parameters 404.

In some implementations, the retrieved design parameters 404 are analyzed to reproduce in whole or in part of the vehicle 401. For example, using design parameters retrieved from a vintage vehicle, the system may reconstruct the original design of the vintage vehicle and enable future replication or reproduction of the vintage vehicle.

In some implementations, the retrieved design parameters 404 are provided to an automated manufacturing system to reproduce the vehicle 401, e.g., on a massive production level.

The automated manufacturing system can reproduce the vehicle 401 in accordance with the retrieved design parameters 404, without requiring any user expertise in CAD or product design. In some implementation, the automated manufacturing system can modify the retrieved design parameters 404 (e.g., changing its 3D measurements) to produce modified versions (e.g., mutants) of the vehicle 401.

In some implementations, the retrieved design parameters 404 are analyzed to evaluate the performance of the vehicle 401. For example, using design parameters retrieved from a vehicle, the system may reconstruct the original design of the vehicle engine and modify the original design in order to improve vehicle performance.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following embodiments are also innovative:

Embodiment 1 is a method, the method comprising: identifying an instantiation of a product. The product is non-biologic and a manufactured item. The method further comprises: determining design parameters associated with the instantiation of the product,

storing the determined design parameters inseparably with the instantiation of the product; and after the instantiation of the product is deployed, retrieving, from the instantiation of the product, the stored determined design parameters; and using the retrieved determined design parameters to evaluate the instantiation of the product. Determining design parameters associated with the instantiation of the product includes: evaluating the instantiation of the product, determining a design intent including an intended use or life of the instantiation of the product, and determining the design parameters that were used in developing a design associated with the instantiation of the product.

Embodiment 2 is the method of embodiment 1, wherein the product is an assembly, and evaluating the instantiation of the product includes: determining sub-assemblies and parts associated with the assembly and instructions for manufacturing or assembling the assembly.

Embodiment 3 is the method of any one of embodiments 1 through 2, the design parameters include material information for use in manufacturing or 3D printing the instantiation of the product.

Embodiment 4 is the method of any one of embodiments 1 through 3, wherein determining the design parameters includes: determining input parameters for the design, and determining algorithms employed on the input parameters.

Embodiment 4 is the method of any one of embodiments 1 through 3, wherein determining the design parameters includes determining one or more characteristics of the instantiation of the product that are unique or included in the instantiation and different from other instantiations of the product.

Embodiment 5 is the method of any one of embodiments 1 through 4, wherein storing the determined design parameters includes storing the determined design parameters in a memory storage unit that is associated with the instantiation of the product.

Embodiment 6 is the method of any one of embodiments 1 through 5, further comprising: physically attaching the memory storage unit to the instantiation of the product to make the memory storage unit inseparable from the instantiation of the product.

Embodiment 7 is the method of any one of embodiments 1 through 6, wherein storing the determined design parameters includes storing the determined design information in an RFID chip associated with the instantiation of the product.

Embodiment 8 is the method of any one of embodiments 1 through 7, wherein storing the determined design parameters includes storing the determined design parameters in a sub-assembly or part of the instantiation of the product.

Embodiment 9 is the method of any one of embodiments 1 through 8, wherein using includes using the retrieved design parameters to evaluate performance of the instantiation of the product.

Embodiment 10 is the method of any one of embodiments 1 through 9, further comprising comparing performance of the instantiation of the product with performance of other different instantiations of the product.

Embodiment 11 is the method of any one of embodiments 1 through 10, further comprising comparing performance of the instantiation of the product with performance of other different instantiations of the product.

Embodiment 12 is the method of any one of embodiments 1 through 11, further comprising: retrieving, from the stored determined design parameters, design intent or goals, and comparing performance of the instantiation of the product to the design intent or goals associated with the instantiation of the product.

Embodiment 13 is a system comprising: one or more computers and one or more storage devices storing instructions that are operable, when executed by the one or more computers, to cause the one or more computers to perform the method of any one of claims 1 to 12.

Embodiment 14 is a computer storage medium encoded with a computer program, the program comprising instructions that are operable, when executed by data processing apparatus, to cause the data processing apparatus to perform the method of any one of claims 1 to 12.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
identifying an instantiation of a product, the product being non-biologic and being a manufactured item;
determining design parameters associated with the instantiation of the product, wherein the determining includes:
evaluating the instantiation of the product,
determining a design intent including an intended use or life of the instantiation of the product, and
determining the design parameters that were used in developing a design associated with the instantiation of the product;
storing the determined design parameters inseparably with the instantiation of the product; and
after the instantiation of the product is deployed,
retrieving, from the instantiation of the product, the stored determined design parameters; and
using the retrieved determined design parameters to evaluate the instantiation of the product.

2. The method of claim 1, wherein the product is an assembly, and evaluating the instantiation of the product includes: determining sub-assemblies and parts associated with the assembly and instructions for manufacturing or assembling the assembly.

3. The method of claim 1, wherein the design parameters include material information for use in manufacturing or 3D printing the instantiation of the product.

4. The method of claim 1, wherein determining the design parameters includes:
determining input parameters for the design, and
determining algorithms employed on the input parameters.

5. The method of claim 1 wherein determining the design parameters includes determining one or more characteristics of the instantiation of the product that are unique or included in the instantiation and different from other instantiations of the product.

6. The method of claim 1 wherein storing the determined design parameters includes storing the determined design parameters in a memory storage unit that is associated with the instantiation of the product.

7. The method of claim 6, further comprising: physically attaching the memory storage unit to the instantiation of the product to make the memory storage unit inseparable from the instantiation of the product.

8. The method of claim 1, wherein storing the determined design parameters includes storing the determined design information in an RFID chip associated with the instantiation of the product.

9. The method of claim 1, wherein storing the determined design parameters includes storing the determined design parameters in a sub-assembly or part of the instantiation of the product.

10. The method of claim 1 wherein using includes using the retrieved design parameters to evaluate performance of the instantiation of the product.

11. The method of claim 10, further comprising comparing performance of the instantiation of the product with performance of other different instantiations of the product.

12. The method of claim 10, further comprising: retrieving, from the stored determined design parameters, design intent or goals, and comparing performance of the instantiation of the product to the design intent or goals associated with the instantiation of the product.

13. The method of claim 10, further comprising: after the instantiation of the product is deployed, using the retrieved determined design parameters to reproduce the instantiation of the product.

14. A system comprising:
one or more computers; and
one or more storage units storing instructions that when executed by the one or more computers cause the system to perform operations comprising:
identifying an instantiation of a product, the product being non-biologic and being a manufactured item;
determining design parameters associated with the instantiation of the product, wherein the determining includes:
evaluating the instantiation of the product,
determining a design intent including an intended use or life of the instantiation of the product, and
determining design parameters that were used in developing a design associated with the instantiation of the product;
storing the determined design parameters inseparably with the instantiation of the product; and
after the instantiation of the product is deployed,
retrieving, from the instantiation of the product, the stored determined design parameters; and
using the retrieved determined design parameters to evaluate the instantiation of the product.

15. The system of claim 14, wherein the product is an assembly, and evaluating the instantiation of the product includes: determining sub-assemblies and parts associated with the assembly and instructions for manufacturing or assembling the assembly.

16. The system of claim 14, wherein the design parameters include material information for use in manufacturing or 3D printing the instantiation of the product.

17. The system of claim 14, wherein storing the determined design parameters includes storing the determined design information in an RFID chip associated with the instantiation of the product.

18. A non-transitory computer storage medium encoded with a computer program, the computer program comprising instructions that when executed by a system cause the system to perform operations comprising:
identifying an instantiation of a product, the product being non-biologic and being a manufactured item;
determining design parameters associated with the instantiation of the product, wherein the determining includes:
evaluating the instantiation of the product,
determining a design intent including an intended use or life of the instantiation of the product, and
determining design parameters that were used in developing a design associated with the instantiation of the product;
storing the determined design parameters inseparably with the instantiation of the product; and
after the instantiation of the product is deployed,
retrieving, from the instantiation of the product, the stored determined design parameters; and
using the retrieved determined design parameters to evaluate the instantiation of the product.

19. The non-transitory computer storage medium of claim 18, wherein the product is an assembly, and evaluating the instantiation of the product includes: determining sub-assemblies and parts associated with the assembly and instructions for manufacturing or assembling the assembly.

20. The non-transitory computer storage medium of claim 18, wherein the design parameters include material information for use in manufacturing or 3D printing the instantiation of the product.

21. The non-transitory computer storage medium of claim 17, wherein storing the determined design parameters includes storing the determined design information in an RFID chip associated with the instantiation of the product.
